(19) United States
(12) Patent Application Publication
(10) Pub. No.: US 2005/0035198 A1
(43) Pub. Date: Feb. 17, 2005

(54) Mobile wireless computer system including devices and methods related thereto

(76) Inventor: Craig A. Wilensky, Ben Salem, PA (US)

Correspondence Address: EDWARDS & ANGELL, LLP, P.O. BOX 55874, BOSTON, MA, 02205, US

(21) Appl. No.: 10/763,411

(22) Filed: Jan. 23, 2004

Related U.S. Application Data
(60) Provisional application No. 60/442,411, filed on Jan. 23, 2003.

(51) Int. Cl. G06K 15/00; G06K 7/10

(52) U.S. Cl. 235/383; 235/462.13

(57) ABSTRACT

Featured is a mobile computer system that includes a computer, a computer embodying wireless technology, and a power supply that is operably coupled to the computer so the computing device or computer is operated and functional remote from fixed power sources. The power supply is configured so as to have a capacity sufficient for powering the computer and any peripherals or other components operably coupled thereto. The mobile system also includes a moving device that is configured and arranged so as to removable support the power supply and the computer as well as any peripherals and so the moving device along with the attached power supply and computer can be selectively moved between different locations such as by wheels.

This application claims the benefit of U.S. Provisional Application Ser. No. 60/442,411 filed Jan. 23, 2003, and U.S. Provisional Application Ser. No. ______ filed Jan. 5, 2004, (entitled Mobile Wireless Retail Shopping Cart Computer System; Attorney Docket Ref. 60559), the teachings of all being incorporated herein by reference.

### FIELD OF INVENTION

The present invention relates to a mobile computer system, more particularly the present invention relates to a mobile wireless computer system that is powered by a mobile power source, more specifically the present invention relates to a mobile wireless computer system for in-store retail operations and sales transactions at the point of the activity.

### BACKGROUND OF THE INVENTION

On a daily, weekly and monthly basis, retailers perform numerous in-store tasks that require utilizing human resources and computer systems for inventory control and point-of-sale transactions. Retailers continuously struggle to efficiently allocate human resources and available computing power to perform operational and point-of-sale tasks such as; in-store pricing/price management (e.g., product labeling, shelf labeling, and price checks); markdown and clearance ticketing (e.g., weekly circulars, shelf talkers, clearance items, standard markdowns, perishables and coupons); mobile point-of-sale transactions (e.g., line busting, sidewalk sales, clearance sales, and one-day sales); holiday and seasonal sales; inventory, receiving, and cycle counting; signage; palnograms, DSD (direct store Delivery) verifications, point-of-sale (“POS”); price verification; returns processing; store-to-store transfers; and computer-aided ordering, including shelf ordering and perishable items control.

Traditionally, such tasks are resource intensive and entail significant expenditures of time and money at each retail outlet. Also, retailers have been restricted operationally because the computers and printers used to perform these tasks can consume significant amounts of power or time for charging, and most are not portable. Typically, such computers and printers are located in the back office of a retail establishment, instead of on the retail floor, thus becoming very operational expensive. Retailers also have attempted to have employees wear the devices but this has proven to be very cumbersome and not very efficient.

It thus would be desirable to provide a new mobile computer system and related devices as well as methods for performing such tasks on the retail floor at the point of activity. It would be particularly desirable to provide such a system, device and method that would embody a mobile wireless computer system including as well various input devices (e.g., scanners) and output devices (e.g., printers) to facilitate the performance of such tasks at the point of activity. It also would be desirable to provide such a system and device that can be easily moved throughout the store or facility in which it is being used and without the need for being connected to the power grid or circuitry of the facility or store to car out its functions. Such systems and devices preferably would be simple in construction and such methods would not require highly skilled users to utilize the device.

### SUMMARY OF THE INVENTION

The present invention features a mobile computer system that, in its broadest aspects, includes a computing device or computer, a moving device and a power supply that is operably coupled to the computing device or computer so the computing device or computer is operated and functional remote from fixed power sources, such as the power grid or power circuitry of the structure or facility in which the mobile computer system is being operated. The computing device or computer is any of known to those skilled in the art and appropriate for the intended application and in more particular embodiments is a wireless computing device or wireless computer more specifically an AC powered wireless computing device or wireless computer. The power supply is arranged so as to have a capacity sufficient for powering the computing device or computer operably coupled thereto. The moving device is configured and arranged so the power supply and the computing device or device are removably attached thereto and so the moving device along with the attached power supply and computing device can be selectively moved between different locations (e.g., includes wheels).

Such a mobile computer system according to the present invention when used in a retail environment can dramatically increase efficiencies for such retailers by creating in effect a wireless modular computing device or computer and thereby provide wireless computing for in-store operations and customer sales transactions at the point of the activity. Beneficial effects of such a mobile computer system in a retail environment include, but are not limited to improving the efficiency and accuracy of these operations and thereby reducing expenditures of limited resources, including time and money. In this way, the mobile computer system of the present invention, removes the restrictions of conventional stationary computer, handheld computers, printing and point-of-sale systems while retaining the ability to carry out the functions associated with such conventional stationary systems.

In more particular embodiments, the mobile computer system of the present invention further includes other system functionalities such as printers, laser and CCD barcode scanners, credit card readers, cash drawers, and wireless print servers. In addition, the moving device is further configured and arranged so such additional functionalities are removably attached or mounted to the moving device so that the moving device can be selectively moved between different locations with such other functionalities attached thereto. Also, such other functionalities that require a source of power to operate are operably coupled to the power supply.

The power supply or power system comprises any of a number of mechanism or sources known to those skilled in the art for generating AC electrical power that is remote from a fixed power source such as the AC electrical outlet in a building that is connected to a large fixed offsite power generation facility. Such power sources include, but are not limited to a self contained battery system that has a DC to AC converter for providing continuous A/C power to the equipment of the mobile wireless computer system.

In more particular embodiments, the batteries comprising the self-contained battery system includes any one of a number of re-chargeable types of batteries. The power supply also is configurable with one or more standard three-prong A/C power outlets so as to provide for easy connection of the equipment of the mobile computer system to the power supply. In more specific embodiments, the batteries output 12, 24 or similar DC voltage and the converter converts the DC output to a standard AC voltage (i.e., standard AC voltage as determined by the country of use; e.g., 110-120 VAC in the US). Supplying a standard AC voltage output allows conventional AC powered computer peripherals such a printers to be coupled to the power supply without the limitations associated with a typical DC power usage. In this way, the power supply provides a system that is very easy to connect to most computers and peripherals without power restrictions, thereby giving retailers the options of selecting and implementing the best computer solutions for their in-store operations and point of sale.

According to another aspect, the present invention features a mobile wireless computer system, and a wireless mobile in-store computer cart capable of supporting a plurality of components powered by a power supply, more particularly a battery based power supply. As herein indicated, the wireless mobile cart device of the invention provides the ability to make these previously stationary computers and printers mobile, such as by mounting and charging portable computers and printers, and supplying the necessary power requirements through an integrated power supply or battery system.

The device of the present invention preferably is a mobile cart on wheels with an integrated power supply that supplies continuous power to components including, but not limited to: wireless computers, wireless handheld computers, printers, laser and CCD barcode scanners, credit card readers, cash drawers, and wireless print servers. Such a device utilizes an optimized power system integrated with the cart that supplies power through, but not limited to: a self-contained battery system that has a DC to AC converter for supplying continuous A/C power to the on-board equipment. The integrated power supply also includes one or more standard three-prong A/C power outlets for easy connection of the equipment on-board the mobile cart device. The power supply/battery system can convert, for example, 12 volt DC battery power to 115 volt AC power. Such a mobile cart device also can accommodate storage, cable management, wire baskets, paper and label bin, shopping bags and wrapping material, and a trash bin.

In further aspects, the mobile cart is any one of a number of commercially available devices that is used in connection with the business of the user, such as for example a conventional shopping cart. In such a case, the cart device is configured and arranged so as to include a support apparatus that is configured and arranged so as to be used with the commercially available device and also so as to support the equipment to be used in connection with the task to be performed, such equipment being hereinabove described. In a more particular embodiment the commercially available device is a shopping cart and the support apparatus is configured so as to be supported by and disposed in the shopping cart.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is a perspective view of a mobile wireless computer system according to one aspect of the present invention;

FIGS. 2A-C are various views (i.e., perspective front and side view) of a mobile wireless computer system according to another aspect of the present invention;

FIG. 2D is a perspective view of an alternative embodiment of the mobile wireless computer system of FIG. 2A with the power supply omitted for clarity;

FIG. 3 is a perspective view of a portion of an illustrative wireless computer system according to another aspect of the present invention;

FIGS. 4A-D are various views (i.e., front, right, top and left) of an illustrative wireless computer system according to an embodiment of the present invention;

FIG. 5 is a perspective view of a mobile wireless computing system according to another aspect of the present invention disposed in a shopping cart;

FIG. 6A is a perspective view of an alternate embodiment of the mobile wireless computing system of FIG. 5 disposed in a shopping cart;

FIG. 6B is a perspective view of the device support apparatus of FIG. 6A; and

FIG. 6C is a perspective view of the mobile wireless computing system of FIG. 6A illustrating locating the power supply on a shelf of the shopping cart.

### DESCRIPTION OF THE PREFERRED EMBODIMENT

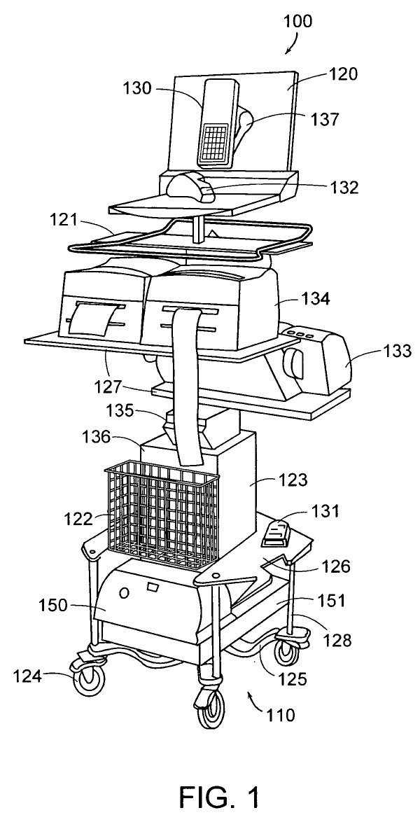

Referring now to the various figures of the drawing wherein like reference characters refer to like parts, there is shown in FIG. 1 a perspective view of a mobile wireless computer system 100 according to one aspect of the present invention. Such a mobile wireless computer system 100 includes a cart device 110, a computing device 130 and associated peripherals, and a power supply 150. The cart device 110 as illustrated on FIG. 1 includes a plurality or more of wheels 112, where the number and arrangement of the wheels is set using any of a number of techniques known to those skilled in the art that provide the desired support and stability to the mobile computer system 100 as the cart device is being moved from location to location within the facility and/or structure it is being used as well as when the mobile computer system is at the point of use location, whereat the functions the computer system is capable of performing are carried out. In the following discussion, when reference is made to reference numeral 130 when referring to a computing device in general, however, when referring to a specific type or form of computing device a alpha character (e.g., a, b) is appended to the end of this reference numeral (e.g., 130a).

In this way, the mobile computer system 100 according to the present invention has the capabilities of performing similar functions as done when using conventional techniques, while not be constrained to performing some of the functions at fixed locations within the facility or structure as occurs with conventional techniques. Such a wireless mobile computer system 100 of the present invention, particularly when used in the retail environment, will dramatically increase efficiencies for retailers because the a wireless computer system is thus capable of carrying out in-store retail operations and customer sales transactions at the point of the activity. The present invention eliminates the restrictions of stationary computers, handheld computers, printing and point of sale systems for conventional systems and techniques. In addition, the wireless mobile computer system 100 of the present invention provides the capability of adapting computers and printers that are traditionally conceived as being stationary so as to be capable of being mobile, including providing a power supply 150 or source that embodies any of a number of techniques and devices known to those skilled in the art (e.g., batteries) that provides the necessary power requirements for such computers and associated peripherals.

As shown in FIG. 1, the cart device 110 includes a frame that is configured and arranged so as to essentially form a plurality or more of sections that each provide the structure and support for any one of the functionalities that make up the operable components/functionalities of the mobile computer system 100 of the present invention. In more particular illustrative embodiments, the frame includes a first section that includes a back plate 120 (e.g., made of clamshell material), which also can function as a work surface. In the illustrated embodiment, there is shown one form of a mobile computing device being mounted to the back plate 120. In particular exemplary embodiments, the back plate 120 and frame are configured and arranged so the back plate 120 can tilt to adjust a viewing angle of the computing device 130, thereby allowing the user to properly focus on the computing device 130. In further embodiments, the back plate 120 is arranged so as to include a plurality of portions that are coupled to a hinge (not shown in detail) whereby one portion of the back plate 120 can be rotated about the hinge so as to close and thereby hide or secure the computing device 130 from theft.

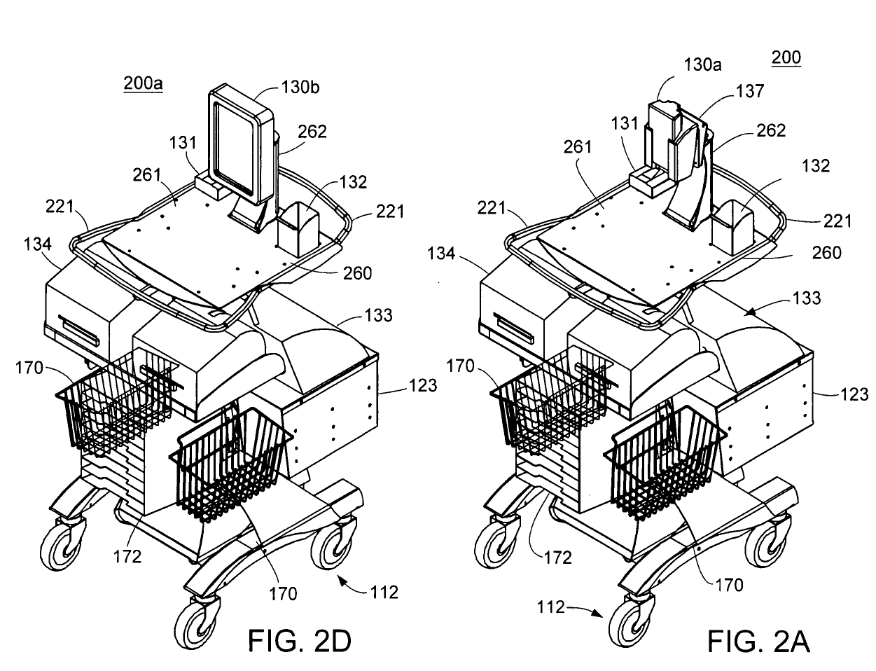

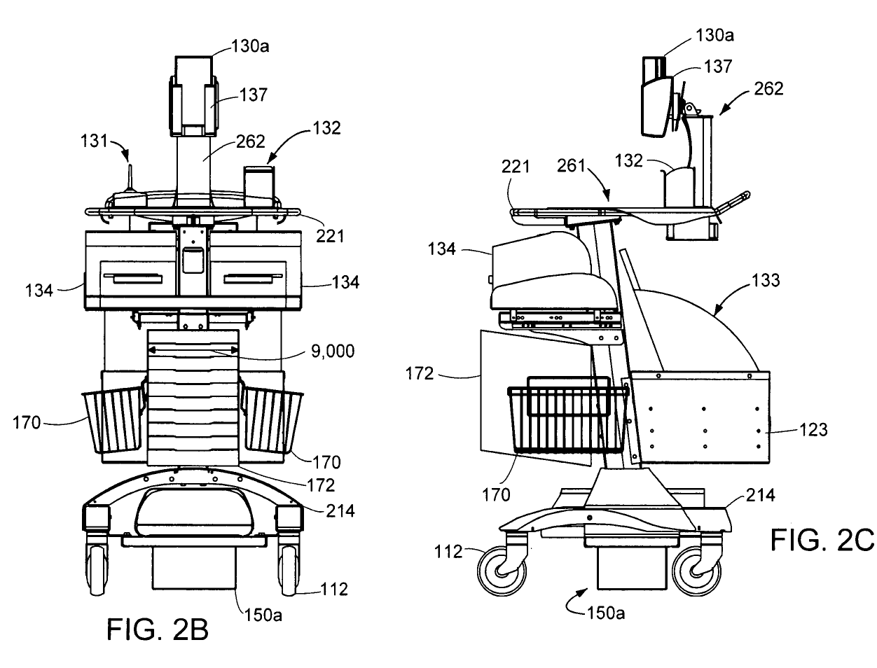

In exemplary embodiments, the computing is a wireless 802.11b IEEE handheld computer 130a that is docked in a docking station 137, which is mounted to a portion of the back plate 120. The docking station 137 allows the handheld computer 130a to be mounted securely to the back plate and also permits easy removal thereof. Also, the docking station 137 is configured so as to be capable of supplying power to the handheld computer 130a. In more particular embodiments, the docking station 137 is operably coupled to the power supply 150 using any of a number of techniques known to those skilled in the art so that the power supply powers the handheld computer 130a. In a specific illustrative embodiment, the docking station 137 includes a power cord that is operably connected to the power supply system 150. In the illustrated embodiment, the power supply 150 is housed within the frame box 123, however, this is not limiting as the power supply is preferably mounted to the frame separate from the frame box as illustrated, for example, in FIGS. 2B-C.

The frame of the cart device 110 also includes a second section that is arranged so as to below the first section. In further embodiments, the second section includes a handle 121 that allows the user to push, pull, or otherwise maneuver the cart device 110. Such a handle 121 and/or second section also is configurable so as to provide storage for various items such as pens, scissors and other accessories. The frame also includes a third section that is supported on the frame and includes one or more shelves 127 for holding computer peripherals (e.g., computer equipment) including components such as printers. Preferably the frame and these shelves 127 are configured and arranged using any of a number of techniques known to those skilled in the art so the shelves can swivel, tilt, and recede to provide better access to the printers and other components.

The frame of the cart device 110 includes a fourth section that preferably includes a wire basket 122 for storing items such as paper, notebooks, pens, scissors, and other accessories, or holding refuse and a fifth section that is configured and arranged so as to support or comprise a frame box 123. The frame box 123 is more particularly configured using any of a number of techniques known to those skilled in the art and more specifically, for cable and power supply management and storage. The frame also includes a sixth section 124 that is configured and arranged so as to include a plurality of wheels 112 for moving the cart device 110. In the illustrated exemplary embodiment, five 3-inch caster wheels designed for smooth and easy movement are provided as the wheels 112 for moving the cart device 110.

The frame of the cart device 110 also includes a seventh section that is configured and arranged so as to include a specially designed wheelbase 125 that provides a low center of gravity to provide stability to the ergonomic small wheelbase and an eighth section preferably that is configured and arranged so as to include a shelf 126 that is supported by a plurality of posts 128. In the illustrated exemplary embodiment, there are five posts (one for each wheel), which are attached to the wheelbase 125. This shelf 126 preferably provides additional storage space. In more particular embodiments, the posts 128 and shelf 126 are configured and arranged (e.g., designed) to stabilize the frame as well as to provide room to mount a power supply 50 underneath.

The mobile computer system 100 according to the present invention also can include any of a number of other functionalities or components used in connection with the performance of desired tasks. As such in further embodiments, the mobile computer system 100 includes a handheld wireless barcode scanner 132 or other device known to those skilled in the art that can be used for scanning barcodes including for example, barcode scanners that are operably coupled to the handheld computer.

After reading one or more barcodes, the barcode scanner 132 transmits wireless information thus obtained to a wireless receiver 131. Because the barcode scanner 132 is wireless, a user typically can roam up to approximately 75 feet away from the wireless receiver and scan barcodes. As is known in the art, a wireless barcode receiver 31 typically can accommodate or be used in combination with a plurality or more, more specifically multiple, wireless scanners 132 at the same time. Consequently, the mobile computer system 100 of the present invention can be localized using the cart device 110 to a position within the facility, structure or building, so as to allow utilization of a plurality or a multiple of wireless scanners 132 thus permit a plurality or multiple users to use the mobile computer system 100 at the same time, thereby further maximizing efficiency.

The computer system also preferably further includes one or more printers as is known to those skilled in the art that are mounted or supported from the cart device 110 and which can be used in combination with the computing device 130 to perform printing operations in connection with the tasks being performed such as for example, signs, label or tags at the point of the activity. In an illustrative exemplary embodiment, the mobile computer system includes an inkjet printer 133, as is known to those skilled in the art, that is capable of printing signs of various sizes, up to or exceeding signs of approximately 8½×11 inches. Preferably, the mobile computer system 100 also includes one or more barcode printers 134, which are used for in-store shelf labeling, product labeling, tagging, markdowns, and pricing. The printers 133 and 134 enable retailers to print from various sizes of labels and signage paper stock. In an alternative embodiment a laser printer is provided instead of, or in addition to either of the barcode or inkjet jet printers 133, 134.

The signage barcode, laser or inkjet printers provide the ability to create in-store signage for the retailer, in-store shelf labeling, product labeling, tagging, markdowns and pricing at the point of the activity. Also, providing a plurality or more of printers, more particularly a plurality or more of different types of printers (e.g., inkjet or barcode printers 133, 134) allows the user such as a retailer to print varying label and signage paper stock without constantly changing label stock.

The inkjet and barcode printers 133, 134 or other printers are connected to the computing device 130 using any of a number of techniques known to those skilled in the art such as for example, to a USB (print server), USB Hub, Ethernet or Wireless Hub for communications from a computing device 130 or handheld computers 130a. As is known to those skilled in the art, hubs (print servers) provide IP addressability to the printers and so the printers 34 do not have to be directly connected to the computing device/handheld computer 130/130a to print. As is known to those skilled in that art, a print job request can be transmitted over the wired or wireless network so as to cause a network printer to print.

In further embodiments, the printers 133, 134 also are connected to the power supply 150 via the frame box 123. In yet further embodiments, one or more of the printers 133, 134 are operably coupled to a wireless print server 136 as is known to those skilled in the art that is, for example, disposed or housed within the frame box 123. The wireless print server 136 is configured so as to be operably coupled to standard parallel printers such as the inkjet and barcodes printers 133, 134 and to convert them to standard wireless 802.11b IEEE IP addressable printers. This is advantageous because the printers 133, 134 then do not rely on the computing device 130 to be connected to them to print. The computing device 130 instead would send and receive wireless requests to and from in-store or corporate computer systems to print to these printers 133, 134 over the wireless 802.11b network. In some situations, the information needed for printing may not reside on the computing device 130 (e.g., information not stored in the computing device 130), but resides on the corporate systems.

The wireless nature of the handheld computer 130a also allows a user to remove the handheld computer from its dock station 137 and still be capable of printing to the printers 133, 134 without requiring physical connection thereto, with the assistance of the wireless print server 136. In further embodiments, the mobile computing system 100 of the present invention can include a portable wireless printer 135. Also, it is contemplated that the portable wireless printer 135 can be operably coupled, for example via the frame box 123, to the power supply 150 so the power supply can be used to charge the portable printer. A portable wireless 802.11b printer 135 provides the capability of allowing a user to print away from the cart device 110 and then return it later to the cart device.

The power supply 150 is configured and arranged so as to form a self-contained system that can supplying the voltage and current for the intended use as well as for a desired period of time to power the computing device 130 as well as any computing peripherals that are connected to the power supply. In more particular embodiments, the power supply 150 is, but is not limited to, a self contained battery system that includes a DC to AC converter configured and arranged to provide continuous A/C power (i.e., AC power at the voltages and frequencies customary for the country in which the power is being supplied, for example 110-120 volt AC for the US) to the equipment contained on the cart device 110, including the computing device 130 as well as any computing peripherals such as the printers 133-134, displays (e.g., LCD type of displays), the barcode wireless receiver 131 and to charge portable equipment such as wireless barcode scanners 132 and a portable printer 135. In further exemplary embodiments, the power supply 150 is configured so as to provide on or more standard three-prong A/C power outlets for easy connection of equipment thereto.

In an exemplary embodiment, the self-contained battery system comprises one or more of a number of batteries known to those skilled in the art, more particularly battery types that are known to be re-chargeable such as NiCd, Nickel metal hydride and the like (e.g., gel cells) and has an output voltage of, for example, 12 or 24 volts DC. In further embodiments, the power supply 150 can comprise other power sources such as for example, fuel cells. Such self-contained battery systems further include any one of a number of converters known to those skilled in the art which can covert the DC voltage and current being supplied to AC voltage and current. More specifically, such converters are configured and arranged so as to regulate the frequency of the AC voltage being generated so as to be in a range acceptable for use with the computing device and peripherals operably coupled thereto. Such a power supply has the beneficial effect that the power supply 150 can provide standard AC output voltages and to connect computers and peripherals without the limitations associated with typical DC power. Further, the configuration and arrangement of the power supply 150 of the present invention has the advantageous effect that it yields a universal system to which most computers and peripherals can be connected to without power restrictions as well as giving retailers the options of selecting and implementing the best computer solutions for their in-store operations and point of sale.

In a further exemplary embodiment, the power supply 150 also is configured and arranged with any one of a number of mechanism or systems known in the art that allow a user to re-charge or replenish the source of the power for example, re-charging the batteries or re-charging the storage containers for a fuel cell type of system. In the case of a power supply 150 including one or more DC batteries and as illustrated in FIG. 1, the power supply includes a power cord 151 that can be connected to a source of AC power and internal circuitry to convert the AC power input into DC voltage and current for charging the one or more batteries.

In alternative embodiments, the power supply 150 is configured and arranged so the external AC power source is an auxiliary source of power and so as to operate or charge one or more of the electrically driven components comprising the mobile computer system 100. It also is contemplated that the power supply can be configured and arranged so as to use the AC power source to charge the one or more batteries making up the power supply (e.g., trickle charge) while operating the mobile wireless computing system 100 and/or charging one or more battery operated functionalities (e.g., wireless barcode scanner) of the system.

As indicated herein, the mobile computing system 100 and certain functionalities or components thereof are configured so as to permit wireless communications between devices, for example wireless communications between the computing device 130 and the print server 136 that is operably coupled to the printers 133, 134 or the wireless communications between the wireless barcode scanner 132 and the wireless receiver 131. It shall be understood that such communications can be effected using any of a number of techniques known to those skilled in the art including, but not limited to those embodying RF and infrared technology. In more specific embodiments, the mechanisms for conducting such wireless communications supports various wireless connectivity standards including, but not limited to: 802.11b, 802.11a and 802.11 g, 802.11, and Bluetooth.

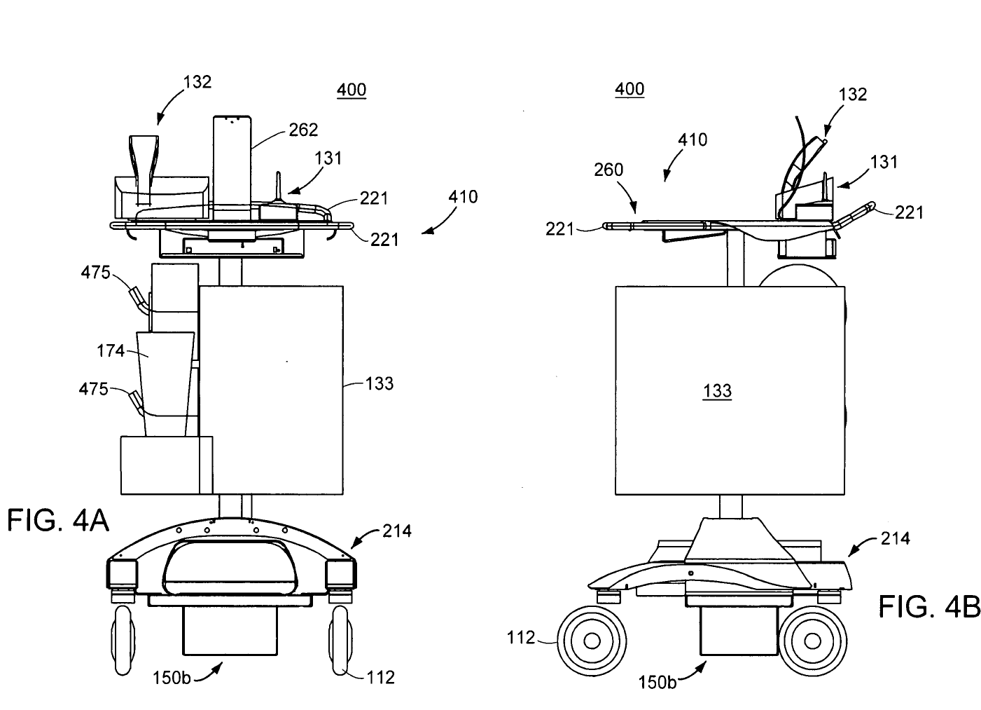

It should be recognized that in addition to forming a support structure for the computing device 130 including the related input/output devices and peripherals the cart device 110 also is configurable so as to contain or include other components, devices and/or functionalities that can be used in the performance of the tasks to be performed. Such other equipment and the like include, but are not limited to, cash drawers, point of sales devices (e.g., cash registers), storage bins 170 (FIG. 2A), shelving 172 (FIG. 2A), and trash bins 174 (FIG. 4A).

The following specific example in a retail environment provides an example of an application (i.e., price management) that illustrates the advantageous or beneficial effect the mobile computer system of the present invention provides over conventional techniques used in connection with price management. Price management is a process that entails: scanning a barcode of each item to identify the item, retrieving the price of the item from the store's retail pricing system, auditing the item price, changing price in the store's computer or on the corporate host computer system if necessary, and printing a new price label. In contrast to conventional techniques, the mobile computer system 100 of the present invention can perform all of these tasks at the point of activity on the retail floor, thereby realizing cost and time savings. Further, the wireless components of the mobile computer system 100 provide improved access to in-store and corporate computer and information systems by extending the reach of conventional wired systems.

Referring now to FIGS. 2A-2C there is shown various views of a mobile wireless computer system 200 according to another aspect of the present invention. Such a mobile wireless computer system 200 includes a cart device 210, a computing device namely a handheld computer 130a and associated peripherals, and a power supply 150a. The cart device 210 as illustrated in FIG. 2 includes four wheel 112, however, as indicated herein the number and arrangement of the wheels is set using any of a number of techniques known to those skilled in the art that provide the desired support an stability to the mobile computer system 200 as the cart device is being moved from location to location within the facility and/or structure it is being used as well as when the mobile computer system is at the point of use location, whereat the functions the computer system is capable of performing are carried out. Reference shall be made to the foregoing discussion regarding FIG. 1 for components or features having the same reference numeral as in FIG. 1. Reference also shall be made to the foregoing discussion for the power supply 150 of FIG. 1 as to the general characteristics and make-up of the power supply 150a not otherwise discussed below.

In the illustrated embodiment, the cart device 210 is configured and arranged so as to include a platform 260 having a top surface and a pedestal 262 that extends outwardly from the top surface of a platform 262 that is secured to the frame of the cart device 210. The pedestal 262 is configured and arranged so as to support the computing device 130 for easy viewing and mounting. In further illustrative embodiments, the computing device is a handheld computer 130a that is secured to a docking station 137 that in turn is attached or secured to the pedestal. Reference shall be made to the foregoing discussion of FIG. 1 as to configuration of the docking station 137 as well as the related operational features, characteristics and configuration.

The top surface 261 of the platform 260 forms a general work surface and also forms a support surface for supporting any of a number of peripherals or functionalities of the mobile computer system 200. In the illustrated exemplary embodiment, the top surface 261 supports the wireless barcode scanner 132 and the wireless receiver 131 that forms or creates the communications link between the handheld computer 130a and the barcode scanner. The top surface 261 is useable to support additional printers 34 that could be any one or more of a barcode, inkjet or laser printers.

The cart device 210 also includes one or more handle(s) 221 that the user can use to push, pull or otherwise maneuver the cart device. In the illustrated embodiment, there are two handles arranged so as to extend outwardly from opposite sides of the platform 260. As indicated herein such handles can be further configured for storage of various items such as pens and other accessories.

The power supply 150a includes a housing member 152 in which is disposed or enclosed the elements that comprise the source of the power (e.g., batteries, fuel cells, etc.). As more clearly shown in FIGS. 2B-C, the power supply 150a is secured to a bottom portion 214 of the frame of the cart device 210, to which the wheels 112 are mounted, using any of a number of techniques known to those skilled in the art. This has the advantageous effect of locating the weight of the power supply 150a low on the device, which in turn has the effect of lowering the center of gravity for the cart device 210. The power supply 150a also is secured to the bottom portion such that a lower surface of the power supply remains spaced from the surface(s) on which the wheels 112 travel.

Referring now to FIG. 2D there is shown an alternate embodiment of a mobile wireless computer system 200a according to said another aspect of the present invention. Such a mobile wireless computer system 200a includes a cart device 210, a computing device and associated peripherals, and a power supply 150a. Reference shall be made to the foregoing discussion regarding FIGS. 1 and 2A-C for the components or features having the same reference numeral as in these figures.

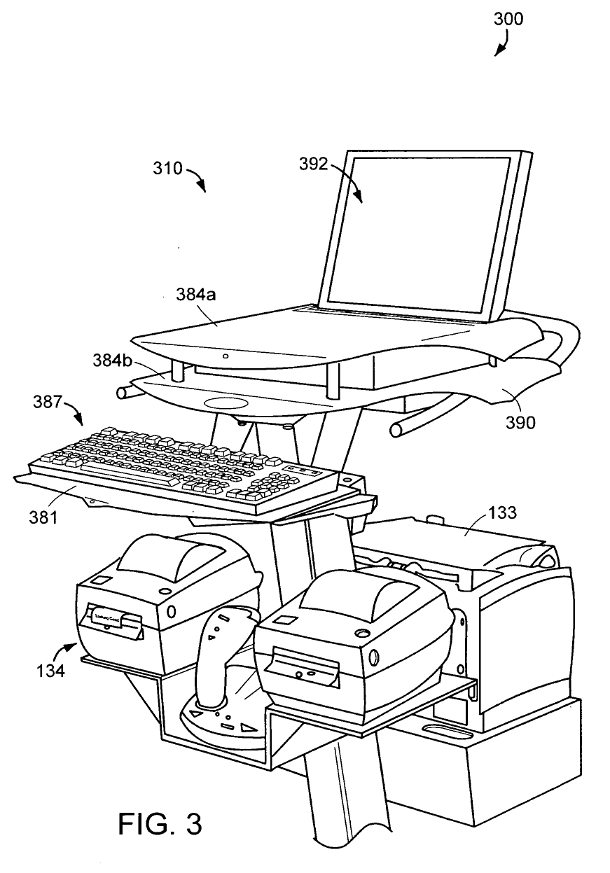

In this illustrative embodiment, the computing device is a wireless computer 130b as is known to those skilled in the art, for example a wireless 802.11b IEEE computer. The wireless computer 130b is mounted or docked to the pedestal 262 using any of a number of techniques known to those skilled in the art. In further embodiments and as illustrated in FIG. 3, the mobile computer system 200a can further include a keyboard input device 382 as is known to those skilled in the art that is operably coupled to the wireless computer 130b.

Referring now to FIG. 3 there is shown a perspective view of a portion of an illustrative mobile wireless computer system 300 according to another aspect of the present invention. Reference shall be made to the foregoing discussion regarding FIGS. 1 and 2A-C for components or features having the same reference numeral as in these figures and other features of the cart device 310 not described hereinafter as well as the power supply 150a. Such a mobile computer system includes a wireless laptop style of mobile computer 390, a display 392 operably coupled to the laptop style of computer, a keyboard input device 282 and a cart device 310. The cart device 310 is configured an arranged so as to provide a shelf 381 secured to the frame of the cart device on which is supported the keyboard input device 382. It also is contemplated that this keyboard shelf 381 is configured and arranged so that the shelf can be moved in any of a number of directions (e.g. up and down, in and out) with respect to the cart device frame so that the keyboard can be positioned at an appropriate position for use by the user.

The cart device 310 also is configured and arranged so as to provide an upper and lower shelf 384a,b to support respectively the laptop style computer 390 and the display 392. The top surface of the upper shelf 384a also is configured so the top surface thereof provides a general work surface and as illustrated in FIGS. 2A-D a support surface for other system functionalities or components such as the wireless barcode scanner 132 and wireless receiver 131. The laptop style computer is any of a number of laptop computers known to those skilled in the art and more particularly a laptop style computer embodying wireless communication elements. The display is any of a number of displays known to those skilled in the art and in an illustrative embodiment is any of a number of liquid crystal display device.

Referring now to FIGS. 4A-D there is shown various view of an illustrative embodiment of a mobile wireless computer system 400 according to the present invention with the computing device 130 removed for clarity. Reference shall be made to the foregoing discussion regarding FIGS. 1 and 2A-C for components or features having the same reference numeral as in these figures and other features of the cart device 410 not described hereinafter as well as the power supply 150a. In the illustrated embodiment, a canister or container 174 is provided to receive trash or recyclable material generated during the performance of a task(s) using the mobile computer system 400.

This embodiment also illustrates configuring the cart device 410 so as to include one or more arms 475. The one or more arms 475 are configured so a roll 2 of paper material used for example in printing out tags, price labels and/or barcode labels for example, can be removably mounted to the cart device 410 so as to facilitate the performance of tasks in the field. For example, a duplicate roll 2 of paper material could be secured to the arm so the user could replace a spent roll without incurring the time loss that would occur if one had to stop working, go get a replacement roll from a storage area and then load it in the printer. In the illustrated embodiment, each of the arms 475 is configured to include a section that is angled upwardly from the portion on which the roll rests thereby removably securing the roll to the cart device 410. It is contemplated that any of the cart devices describer herein can be configured so as to include one or more of such arms.

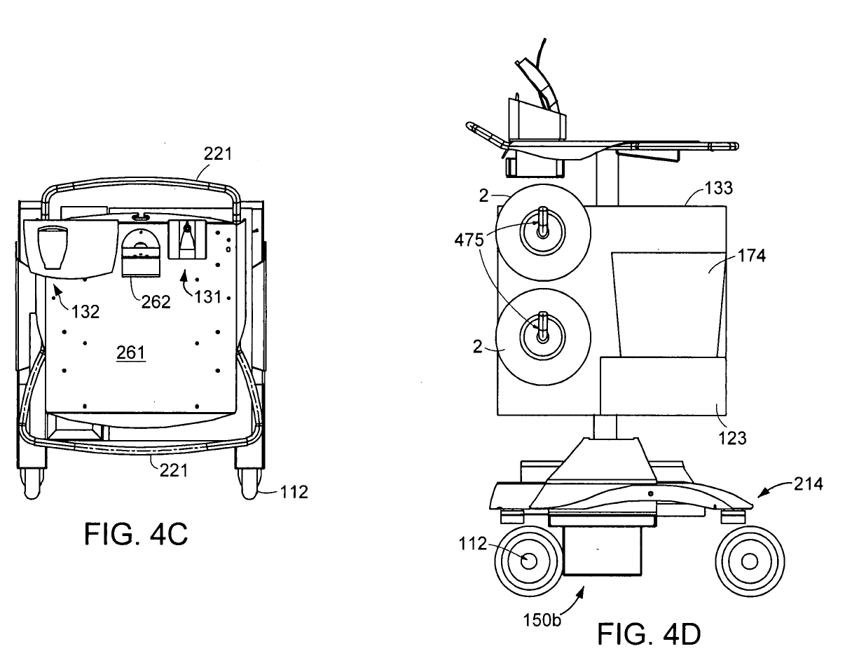

Referring now to FIG. 5, there is shown a perspective view of a mobile wireless computer system 500 according to another aspect of the present invention. Reference shall be made to the foregoing discussion regarding FIGS. 1-4 for components or features having the same reference numeral as in these other figures. Such a mobile wireless computer system 500 is more particularly configured and arranged so as to adaptable for use in combination with existing devices available for use in connection with the particular business of the user. In the illustrated embodiment, the mobile wireless computer system 500 is adapted for use with a well-known shopping cart 4 that is provided by a wide number of retail businesses for use by their customers during their shopping, however, as indicated above the mobile wireless computer system of the present invention is limited to just the illustrated embodiment as hereinafter described. The shopping cart 4 being illustrated includes a shopping cart section 5 and a child seat section 3.

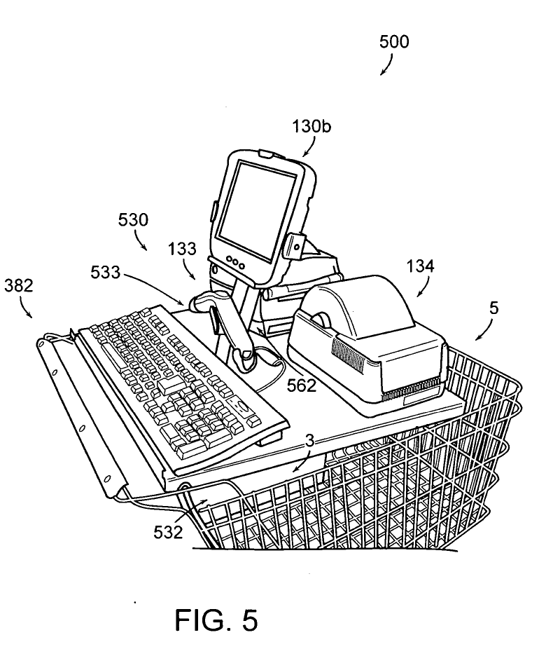

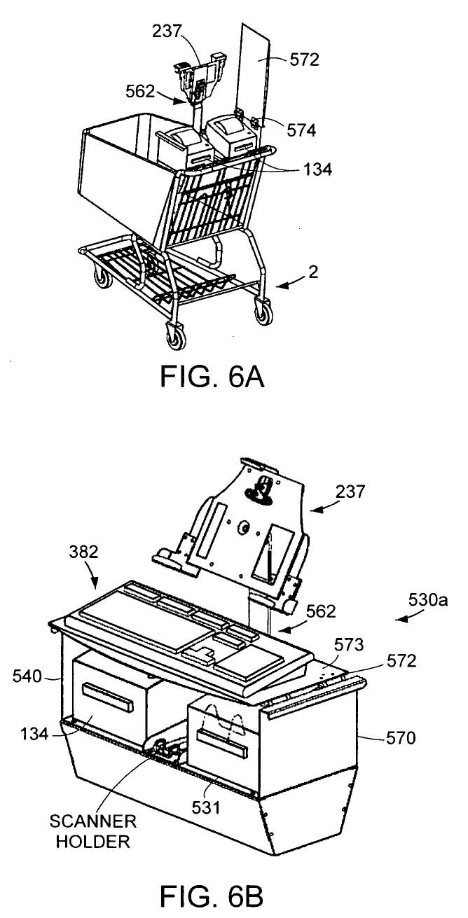

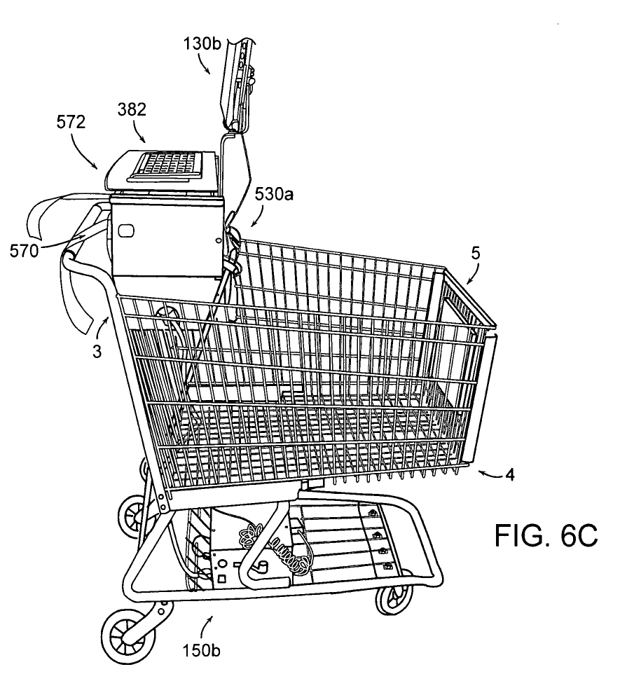

The mobile wireless computer system 500 according to this aspect of the present invention includes a device support apparatus 530 that is configured and arranged so as to support all of the equipment for a given task to be conveyed via the shopping cart 2. Reference shall be made to the foregoing discussion of FIG. 1 regarding the power supply 150 for the details, make-up and characteristics of the power supply 150b (FIG. 6C) of this mobile wireless computer system 500.

The device support apparatus 530 of the illustrated is configured and arranged so as to be easily inserted into a portion of the shopping cart 4, for example the child's seat portion 3. It also is within the scope of the present invention for the device support apparatus 530 to be configured and arranged so it is received in the shopping cart section 5. While shopping carts 4 are readily available in a great many of retail businesses, there are other devices used in such types of businesses by customers or the retail personnel to move objects about the business. It is within the scope of the present invention for the device support apparatus 530 of the present invention to be adapted for use with such other devices.

The device support apparatus 530 includes a housing portion 532 that is generally configured so as to be received within the child seat portion 3 and in more particular embodiments, a lower surface of the housing portion is configured so it rests upon the members of the shopping cart 4 that generally form or comprise the seating surfaces of the child seat portion. The housing portion 532 includes a top surface 531 that forms a general work surface and also forms a support surface on which is mounted or disposed various components of the mobile computer system such as for example, a keyboard input device 382, a barcode scanner 133, a wireless receiver 131 and one or more printers such as for example, a barcode printer 134, an inkjet printer 133 (FIG. 1) and/or laserjet type of printer.

The device support apparatus also includes a pedestal section 562 that extends generally upwardly from the top surface 531 of the housing portion 532. A wireless computing device such as a wireless computer 130b is supported from the pedestal. In more particular embodiments, a docking station 237 is secured to the pedestal in which the wireless computer 130b is received and which supports and powers the wireless computer. As described herein, the docking station and pedestal are configured and arranged so as to cooperate so as to allow the user to move the wireless computer (e.g., rotate) in any of a number of directions to allow the user to position the wireless computer so as to be in an appropriate position for viewing the display screen and/or operating the computer.

In an embodiment of the present invention, the power supply 150b includes a housing that is disposed within the child seat portion 3 so as to be located between the seating members of the child seal portion and the lower surface of the device support apparatus-housing portion 532. In another embodiment, the power supply 150b is placed in the shopping cart section 5 or on a rack typically found on shopping carts 2 that is below the shopping cart section as is illustrated in FIG. 6C. The power cabling is routed between the power supply 150b and the devices/support apparatus using any of a number of techniques known to those skilled in the art. In further embodiments, the shopping cart section 5 also can be utilized to provide storage for items such retailers goods, for cable management, storage of paper and labels for the tasks to be performed, shopping bags, wrapping material, trash bin, pens, scissors, and other accessories.

Referring now to FIGS. 6A there is shown a perspective view of an embodiment of a mobile wireless computer system 500a and FIG. 6B is a perspective view of the device support apparatus 530a of this embodiment. As indicated above, FIG. 6C illustrates the embodiment where the power supply 150b is located on a shelf below the shopping cart section 5. For clarity, the computing device, more particularly the wireless computer 130b has been omitted for clarity in both FIGS. 6A and 6B. Reference shall be made to the foregoing discussion regarding FIGS. 1-5 for components or features having the same reference numeral except as otherwise described below.

The device support apparatus 530a of this embodiment differs from that shown in FIG. 5 in the following respects. In this embodiment, the docking station 237 or tablet mount and the pedestal 562 are configured and arranged so as to allow the docking station 237 to pivot, be moved up/down and/or moved side to side so as to allow the user to operate the mobile computing system from the front or the sides of the shopping cart 2. Also, the device support apparatus 530a includes two vertical side members 570 that extend upwardly from the top surface 531 and parallel to each other and a pivotable platform member 572. The platform member 572 has a top surface 573 that forms a support surface for the keyboard input device 382 and is rotatably or pivotable secured to one of the vertical side members by means of one or more hinges 574. In more particular embodiments, the keyboard input device is removably secured or attached to the top surface 573/the platform member 572 such that when the platform member is rotated about a pivot point to a vertical position, the keyboard input device 382 does not slide off the platform member.

The platform member 572 and the two vertical side members 570 also are more particularly arranged to cooperate with the housing top surface 531 so as to form in effect an open ended compartment in which is disposed one or more printers. In the illustrated embodiment, two barcode printers 134 are located in this open ended compartment. The pivotable platform member 572 also provides a mechanism by which a user can access the printer(s) located in the open-ended compartment for servicing and replacement as well as allowing a user to re-fill the printer with the paper medium and/or printing cartridges.

Although a preferred embodiment of the invention has been described using specific terms, such description is for illustrative purposes only, and it is to be understood that changes and variations may be made without departing from the spirit or scope of the following claims.

Incorporation by Reference

All patents, published patent applications and other references disclosed herein are hereby expressly incorporated by reference in their entireties by reference.

Equivalents

Those skilled in the art will recognize, or be able to ascertain using no more than routine experimentation, many equivalents of the specific embodiments of the invention described herein. Such equivalents are intended to be encompassed by the following claims.

1. A device for performing a task at a point of activity, comprising:
a frame;
a computing device connected to the frame and operably linked to a power supply;
a barcode scanner operably linked to a barcode receiver on the frame; and
a printer for printing barcodes.

2. The device of claim 1, and further including a printer for printing signs.

3. The device of claim 1, wherein the computing device is a wireless handheld computer.

4. The device of claim 1, wherein the computing device is a wireless 802.11b handheld computer.

5. The device of claim 1, further including a back plate that receives the computing device, the back plate being tiltably mounted on the frame.

6. A mobile wireless computer system for performing a task at a point of activity, comprising:
an apparatus including a wireless computing device mounted on a frame;
a wireless handheld barcode scanner which transmits wireless signals to a barcode receiver provided on the apparatus; and
a barcode printer mounted on the apparatus and operably linked to a wireless print server provided on the apparatus.

7. An apparatus for performing a task at a point of activity, comprising:
a supporting device being configured and arranged so as to be removably supported by a portion of a shopping cart;
a computing system including a computing device being removably coupled to the supporting apparatus so as to be operable by a user;
a power supply outputting a voltage compatible with the computing device, the power supply be configured so as to be removably supported by the shopping cart and being operably coupled to the computing device; and
whereby the computing device and the power supply are moveable between different locations by the user pushing, pulling or otherwise maneuvering the shopping cart.

8. The apparatus of claim 7, wherein the shopping cart includes a seat portion and wherein the supporting device is configured and arranged so as to be received within and supported by the shopping cart seat portion.

9. The apparatus of claim 7, wherein the shopping cart includes a cart portion and wherein the supporting device is configured and arranged so as to be received within and supported by the cart portion.

10. The apparatus of claim 7, wherein:
the computing system further includes a wireless barcode scanner and wireless barcode receiver that is operably wirelessly linked to the barcode scanner and is operably coupled to the power supply, and
the supporting device is configured and arranged so as to support the wireless barcode receiver.

11. The apparatus of claim 10, wherein:
the computing system further includes a printer that is operably coupled to the computing device and to the power supply, and
the supporting device is configured and arranged so as to support the printer.

12. The apparatus of claim 11, wherein the printer is capable of printing one of barcodes or signs.

13. The apparatus of claim 7, wherein the computing device is one of a wireless handheld computer or a wireless 802.11b handheld computer.

14. The apparatus of claim 7, wherein the supporting device further comprises a computing device support member and wherein the computer device support member is configured and arranged so the computing device is tiltable.

15. The apparatus of claim 7, wherein the power supply is configured and arranged so as to output a voltage lying in a predetermined range for a standard AC voltage and wherein the computing device and peripherals thereof are configured so as to be powered by the standard AC voltage.

16. The apparatus of claim 15, wherein the power supply further includes:
a DC power source that provides a DC voltage output; and
a converter operably coupled to the DC power source fore converting the DC voltage output to the AC voltage in the predetermined range.

17. The apparatus of claim 16, wherein the DC power source is one or more re-chargeable type of batteries.

18. An apparatus for performing a task at a point of activity in combination with a shopping cart, said apparatus comprising:
a supporting device being configured and arranged so as to be removably supported by a portion of the shopping cart;
a computing system including a computing device being removably coupled to the supporting apparatus so as to be operable by a user;
a power supply outputting a voltage compatible with the computing device, the power supply be configured so as to be removably supported by the shopping cart and being operably coupled to the computing device; and
whereby the computing device and the power supply are moveable between different locations by the user pushing, pulling or otherwise maneuvering the shopping cart.

19. A mobile wireless computing system, comprising:
a wireless computing device;
a moving device;
a power supply being configured and arranges so as to output a voltage that is compatible with an operating voltage for the computing device, for a predetermined time, where the power supply is operably coupled to the wireless computing device; and
wherein the moving device is configured and arranged so the wireless computing device and the power supply are supported by the moving device, whereby the wireless computing device and the power supply are moveable between different locations by the user pushing, pulling or otherwise maneuvering the moving device.

20. An apparatus for performing a task at a point of activity, comprising:
a supporting device being configured and arranged so as to be removably supported by a portion of a moving device;
a computing system including a computing device being removably coupled to the supporting apparatus so as to be operable by a user;
a power supply outputting a voltage compatible with the computing device, the power supply be configured so as to be removably supported by the moving device and being operably coupled to the computing device; and
whereby the computing device and the power supply are moveable between different locations by the user pushing, pulling or otherwise maneuvering the moving device.

21. The device of claim 1, further including a power supply that is removably mounted to the frame and being operably coupled to the computing device, the power supply outputting a voltage that is compatible with an operating voltage for the computing device, for a predetermined time.

22. The device of claim 21, wherein the power supply is configured and arranged so an AC voltage is outputted, which AC voltage is in a predetermined range for a standard AC voltage and wherein the computing device and peripherals thereof are configured so as to be powered by the standard AC voltage.

23. The device of claim 22, wherein the power supply further includes:
a DC power source that provides a DC voltage output; and
a converter operably coupled to the DC power source fore converting the DC voltage output to the outputted AC voltage in the predetermined range.

24. The apparatus of claim 23, wherein the DC power source is one or more re-chargeable type of batteries.
